(19) United States
(12) Patent Application Publication
(10) Pub. No.: US 2015/0024114 A1
(43) Pub. Date: Jan. 22, 2015

(54) DECORATION, DECORATIVE BASE AND METHOD FOR MAKING SAME

(71) Applicant: Karen Louise Coubrough, Parkwood (AU)

(72) Inventor: Karen Louise Coubrough, Parkwood (AU)

(21) Appl. No.: 14/376,513

(22) PCT Filed: Feb. 4, 2013
(86) PCT No.: PCT/AU2013/000104

§ 371 Date: Aug. 4, 2014

(30) Foreign Application Priority Data
Feb. 3, 2012 (AU) 2012900402

(51) Int. Cl. A23G 3/34; A23G 3/50

(52) U.S. Cl. CPC A23G 3/343; A23G 3/50; A23V 2002/00
USPC 426/660

(57) ABSTRACT

The present invention provides a decoration formed from a mixture of a decorative base and a colour additive, the decorative base comprising a quantity of a thickening/hardening compound, pure icing sugar and water, wherein the decoration sets in less than 24 hours from being created, the decoration having a colour matching the colour additive.

### TECHNICAL FIELD

The present invention generally relates to edible decorations. In particular the present invention relates to a decorative base which is used to produce edible decorations.

### BACKGROUND ART

When baking, particularly cakes and puddings, the finished baked product is typically decorated. The decoration ranges from simple decoration, such as a layer of icing or cream spread over the top of the cake, to detailed decoration which may incorporate intricate designs, shapes and objects. For instance, cakes having detailed decoration are typically ordered for a special occasion, such as a wedding or a special birthday.

For those cakes having detailed decoration, the decorator uses a variety of products to create decorations either directly upon the cake, or on paper, upon which it is allowed to set before transferring to the cake.

Edible decorations are typically created from a thickening/hardening base of CMC powder. Water is added to the powder to create a white paste/gel which may then be piped to create a decoration, which is typically white in colour. The white gel/paste typically takes at least 24 hours to set.

A significant limitation when creating decorations is the ability of the decorator to create a decoration with vibrant or metallic colours. If the decorator requires a coloured decoration, the decorator must paint the set decoration with a non-toxic paint. The time and labour required to produce a coloured decoration is therefore quite lengthy. Also, for designs which are not created directly on the cake, surplus decorations are required to be produced in the event that the initial ones break whilst transferring them onto the cake.

There are some products which may be added to the white paste/gel to provide colour to the finished product. However, these products either provide a decoration which remains tacky and will not set, or the colour of the set decoration is not appealing, particularly with metallic colours. For example, mixing a silver metallic colour with the white paste/gel before creating the decoration will result in a grey, matt colour as opposed to a bright vibrant silver metallic colour.

When creating decorations using current products, the decorator is limited to what they may create, and may often require significant preparation and lead in times to be able to create the decorations.

Further disadvantages of the prior art include excessive shrinkage as it sets leading to cracking/breakage, and can have an unpleasant taste.

The preceding discussion of the background art is intended to facilitate an understanding of the present invention only. The discussion is not an acknowledgement or admission that any of the material referred to is or was part of the common general knowledge as at the priority date of the application.

### SUMMARY OF INVENTION

It is an object of this invention to provide a decorative base which ameliorates, mitigates or overcomes, at least one disadvantage of the prior art, or which will at least provides the public with a practical choice.

The present invention provides a method of creating a decorative base for use in creating edible decorations, the method comprises:
mixing a quantity of a thickening/hardening compound with water;
leaving the mixture over a predetermined period of time;
adding a quantity of pure icing sugar to the mixture to provide the decorative base;

wherein once the decorative base forms a decoration it will set in less than 24 hours.

In contrast to the prior art, the setting time is significantly reduced. The setting time for gel/paste is at least 24 hours under normal conditions, with prior art mixtures not even setting after weeks.

The present invention provides a method of creating an edible decoration, the method comprises:

making a decorative base by mixing a quantity of a thickening/hardening compound with water, leaving the mixture over a predetermined period of time, before adding a quantity of pure icing sugar to the mixture;

adding a colour additive to the decorative base;

wherein once the colour additive is mixed with the decorative base a decoration can be formed, the decoration setting in less than 24 hours.

The present invention further provides a method of creating a decorative base for use in creating edible decorations having a metallic coloured finish, the method comprises:

mixing a quantity of a thickening/hardening compound with water;

leaving the mixture over a predetermined period of time;

adding a quantity of pure icing sugar to the mixture to provide the decorative base;

adding a metallic colour additive to the decorative base;

wherein once the colour additive is mixed with the decorative base a decoration can be formed, the decoration setting in less than 24 hours, the decoration being having a metallic coloured appearance once set.

The present invention further provides a method of creating an edible decoration having a metallic coloured finish, the method comprises:

making a decorative base by mixing a quantity of a thickening/hardening compound with water, leaving the mixture over a predetermined period of time, before adding a quantity of pure icing sugar to the mixture;

adding a metallic colour additive to the decorative base;

wherein once the colour additive is mixed with the decorative base a decoration can be formed, the decoration setting in less than 24 hours, the decoration having a metallic coloured appearance once set.

The predetermined period of time may be less than 24 hours. Preferably the predetermined period of time is 1 hour or less.

The present invention further provides a decorative base for use in creating edible decorations, the decorative base comprises a quantity of a thickening/hardening compound, pure icing sugar and water wherein once the decorative base forms a decoration it will set in less than 24 hours.

Preferably the decorative base, after being mixed with a colour additive, sets within 12 hours of being formed.

Preferably the decorative base, after being mixed with a colour additive, sets within four hours of being formed.

Preferably the decorative base, after being mixed with a colour additive, may be moulded to the required shape.

Preferably the decorative base may be rolled flat prior to setting. Once rolled the decorative base may be added to the baked product prior to setting.

The water may be cold water at a temperature less than room temperature.

The thickening/hardening compound may be sodium carboxy-methyl cellulose gum, which is known as CMC.

Preferably a ratio equivalent to approximately eight teaspoons of CMC is added to two cups of water.

Preferably the ratio of pure icing sugar to the mixture is equivalent to approximately 3 gms of pure icing sugar to 14 gms of the mixture. This will produce 17 gms of decorative base.

The decorative base may include a quantity of potassium sorbate. Potassium sorbate acts to prevent bacteria in the base which could otherwise lead to mold.

The decorative base may have an alcohol based additive mixed therein. The alcohol base acts to prevent bacteria in the base which could otherwise lead to mold. The alcohol based additive may be added as part of another additive. For instance an colour additive may be mixed with the decorative base where the colour additive is alcohol based.

Preferably additional materials may be added to the decorative base prior to piping of the decorative base, wherein the additional materials still allow the setting of the material. This allows metallic colours, for example, to be added to the decorative base prior to piping the decorative base. Once the base is set the decorative base will retain the metallic colour. It also cuts down on preparation time of the decoration as the decoration does not need to be painted once set.

The present invention further provides a decoration comprising a decorative base as herein before described, mixed with an additive prior to forming the decoration, wherein the additive allows the decoration to set.

The present invention further provides a decoration formed from a mixture of a decorative base and a colour additive, the decorative base comprising a quantity of a thickening/hardening compound, pure icing sugar and water, wherein the decoration sets in less than 24 hours from being created, the decoration having a colour matching the colour additive. Hence, where the colour additive is a metallic gold colour additive the set decoration will also have a gold metallic finish.

Preferably the colour additive is a metallic colour additive. Metallic colour additives includes lustre powder, glitter pain and metallic paint.

Preferably the decoration sets within 12 hours of being formed.

Preferably the decoration sets within four hours of being formed. Setting time may be shortened by placing the decoration formed from the decorative base in a fan forced environment.

Preferably once the decorative base has set, the decoration may be softened with water such as may be applied by a damp cloth or spray.

Preferably a decoration made from the decorative base as above described may be attached to the cake by dampening the area of the decoration which is to be attached to the cake and the decoration applied thereto. This negates the need to use any additional icing or other product to stick the decoration to the cake.

Preferably the decoration formed from the decorative base may be made from natural ingredients. When adding natural colouring, the colour must be natural colouring. As natural colouring is brighter than other colouring, less colour is required. Tapioca flour may then be used to replace the quantity of colour not used. Typically when using natural colours an ⅛ of a teaspoon of colour is added to approximately 3 teaspoons of ground tapioca flour.

Preferably the decoration formed from the decorative base may be frozen and, once thawed, is still stable.

Preferably the decoration remains flexible once set.

A dipping solution may also be used to assist in the process. The dipping solution may comprise alcohol and essence, such as rose essence.

The present invention provides a decorative base for use in creating edible decorations, the decorative base comprises a hardening compound, pure icing sugar and water. The quantities of each component may be equivalent to eight teaspoons of hardening compound, to two cups of water and 3 gms of pure icing sugar per 14 gms of the hardening compound and water combination.

The hardening compound may be sodium carboxymethyl cellulose gum, which is known as CMC.

In contrast to prior art, the present invention negates the need to paint the decoration once the decoration has dried in order to obtain metallic coloured decorations, for instance. It therefore also allows more decorations to be applied directly to the baked product as there is no painting required after the decoration has set. The decorative base also provides a decorative material which sets significantly faster. With the prior art, if metallic colours, such as silver or gold was to be added to the CMC gel/paste the resultant colour would be a dull grey.

The decorative base may set only if the colour additive is mixed therein. The decorative base with colour additive may be flexible once set. Decoration made from the decorative base may be flexible for several months after it has been mixed.

In some cases it is necessary to create the decoration on a substrate before transferring it to the product to be decorated. Preferably the decoration, once set, can be easily removed from the substrate. The substrate may be parchment paper. This is not the case with some of the prior art which tend to stick to the substrate/parchment paper once it has set.

The present invention further provides a method of creating a decorative base for use in creating edible decorations, the method comprises:
boiling water and allowing water to cool
adding 16 teaspoons of thickening/hardening compound to the water in 1 litre portions;
blending the mixture to reduce the particle size;
place the mixture in a cool region and leave for 1 hour;
dividing the mixture into 14 g portions and adding 3 gm of pure icing sugar to the mixture to provide the decorative base;

wherein once the decorative base forms a decoration it will set in less than 24 hours.

The method may include the step of adding 5 gm of potassium sorbate per 3 litres of water before the thickening/hardening compound is added to the water.

The method may include adding 3 gm of a colour additive to the mixture.

Where the colour additive is alcohol based the colour additive may be added at any time prior to using the decorative base.

Where the colour additive is not alcohol based the colour additive may be added just prior to using the decorative base.

Preferably the mixture is blended in a thermomix®.

The present invention further provides a kit comprises:

a dispenser for dispensing a decorative base, the dispenser comprising a first mixture;

a sachet of pure icing sugar;

wherein the first mixture and pure icing sugar are mixed together to provide the decorative base as herein before described.

Preferably once mixed, the dispenser contains approximately 17 gm of decorative base.

Preferably 3 gm of colour additive is added to the decorative base prior to piping the decoration.

Preferably the dispenser can be used to pipe the decorative base and colour additive mixture.

The kit may incorporate a container to mix the decorative base.

The first mixture may be made by mixing a quantity of a thickening/hardening compound with water and leaving the mixture over a predetermined period of time.

The present invention further provides a decoration formed from a decorative base as herein before described wherein the decorative base is mixed with a colour additive which will allow the decoration to set.

Preferably the colour additive is a metallic colour additive and the resulting decoration retains the metallic colour appearance once set.

### BRIEF DESCRIPTION OF THE DRAWINGS

Several applications of an embodiment of the present invention are described with reference to the accompanying drawings in which:

FIGS. 1, 2 and 4 show several decorated puddings decorated with decorations made from a decorative base according to an embodiment of the present invention;

FIG. 3 show black flexible strips made from the decorative base;

FIG. 5 show gold spirals made from the decorative base;

FIG. 6 show lace decorations made from the decorative base; and

FIG. 7 shows gold leaf sheets made from the decorative base.

### DESCRIPTION OF EMBODIMENTS

The figures illustrate a multitude of new decorations which may be made using a decorative base of the present invention. These designs were not possible using the prior art methods and represent a significant advance in cake decoration.

The present invention according to a first embodiment is in the form of a decorative base which is edible. The decorative base is produced using a hardening compound such as CMC powder, water and pure icing sugar.

To produce the decorative base for use in creating edible decorations, approximately eight teaspoons of CMC is added to two cups of water. The product is mixed to provide a mixture which is then left for 24 hours, under normal room conditions. At the end of this period 14 gms of the mixture is mixed with 3 gms of pure icing sugar to provide a decorative base.

Once the decorative base is prepared, additives may be added to the decorative base to produce different effects.

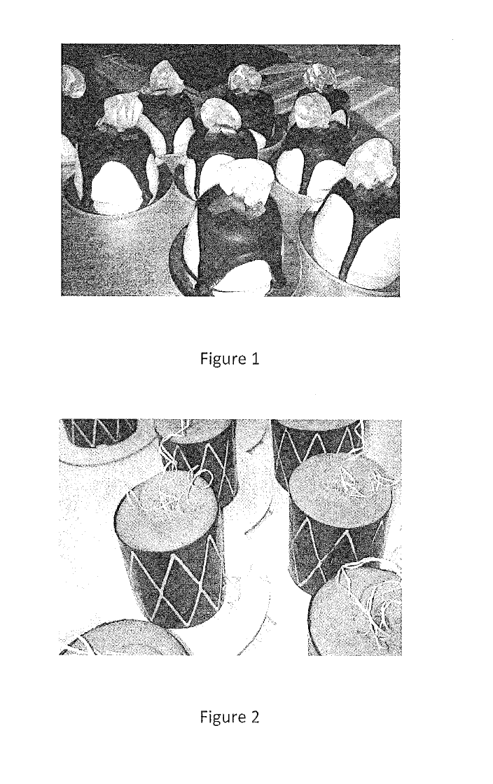

Referring to FIGS. 1 and 7, the gold leaf decorations were created by adding a metallic gold colour additive to the decorative base. Once mixed, a quantity was thinly spread onto a plastic sleeve and allowed to dry. Once dried the material was shaped.

Also in FIG. 1 red spiral decorations are visible. These were created by adding red metallic colour additive to the decorative base before piping it onto plastic. When they were semi dried they were wrapped around a pen and allowed to set completely.

In FIG. 2, the decorative base with a gold colour added thereto has been thinly piped. This illustrates how fine the decoration can be made using the decorative base of the present invention.

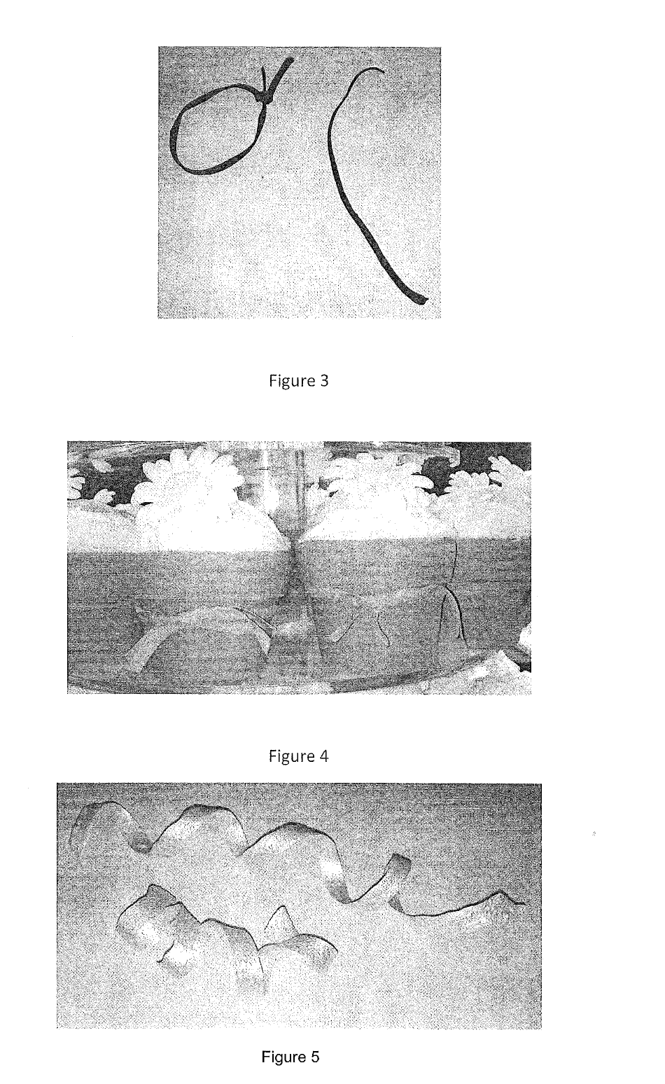

FIG. 3 shows a black ribbon made from the decorative base when mixed with a black paste. This paste is slightly different to the colours added to the decorative base as mentioned above. The paste has provided the decorations with a degree of flexibility whilst not being tacky.

In FIG. 4, the cake has a ribbon wrapped around the pot. This ribbon is made from the decorative base mixed with a paste colour, which is then piped onto plastic. When nearly dry the decoration was wrapped around the pot. This is not achievable with prior art materials.

FIG. 5 show gold spiral ribbons. These were created by adding gold colour additive to the decorative base before piping it onto plastic. When they were semi dried they were wrapped around a pen and allowed to set completely.

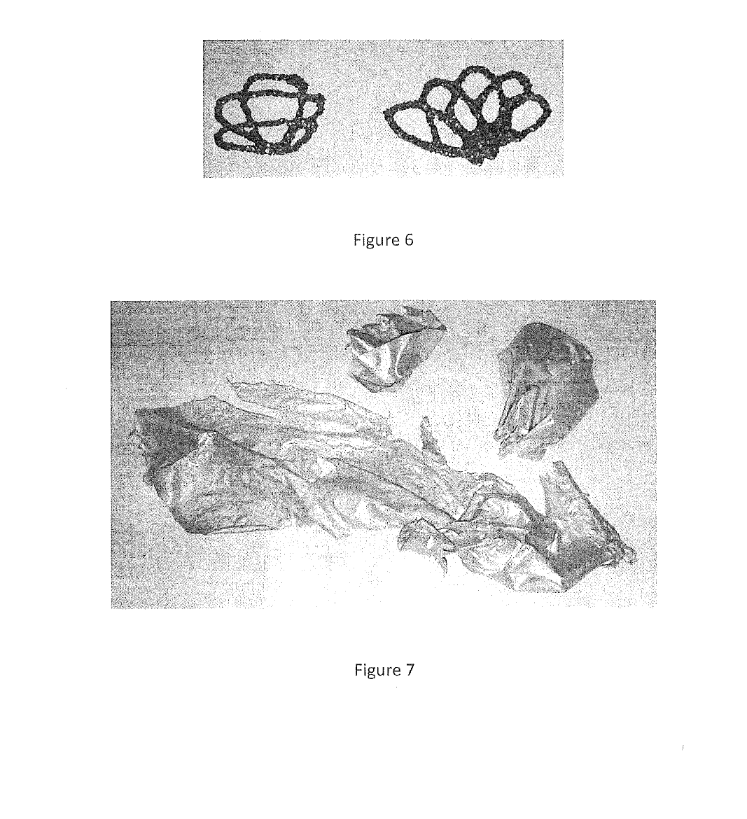

FIG. 6 show glitter lace pieces. These were created by adding a glitter powder additive to the decorative base before piping it onto plastic.

The decorative base of the current invention can be mixed with a variety of materials including metallic food paint, dust powders, metallic dust powders, glitter powders and paste food colours to create a variety of decorations. These decorations include spiral, lace pieces, paper (which may be cut into required shape), ribbons and flexible strands.

The decorative base is described in relation to a decorative base which is piped to produce a decoration. However, the decorative base may be used to form a decoration using any desired process, such as by moulding or using a dispensing pen. These additional processes are within the scope of this invention.

Modifications and variations such as would be apparent to the skilled addressee are considered to fall within the scope of the present invention. The present invention is not to be limited in scope by any of the specific examples described herein. These examples are intended for the purpose of exemplification only. Functionally equivalent products, formulations and methods are clearly within the scope of the invention as described herein.

Throughout this specification, unless the context requires otherwise, the word “comprise” or variations such as “comprises” or “comprising”, will be understood to imply the inclusion of a stated integer or group of integers but not the exclusion of any other integer or group of integers.

1. A method of creating a decorative base for use in creating edible decorations, the method comprises:
mixing a quantity of a thickening/hardening compound with water;
leaving the mixture over a predetermined period of time;
adding a quantity of pure icing sugar to the mixture to provide the decorative base;
whereupon the decorative base being used to form a decoration will result in the decoration setting in less than 24 hours.

2. A method of creating an edible decoration, the method comprises:
making a decorative base by mixing a quantity of a thickening/hardening compound with water, leaving the mixture over a predetermined period of time, before adding a quantity of pure icing sugar to the mixture;
adding a colour additive to the decorative base;
wherein once the colour additive is mixed with the decorative base a decoration can be formed, the decoration setting in less than 24 hours.

3. A method of creating an edible decoration having a metallic coloured finish, the method comprises:
making a decorative base by mixing a quantity of a thickening/hardening compound with water, leaving the mixture over a predetermined period of time, before adding a quantity of pure icing sugar to the mixture;
adding a metallic colour additive to the decorative base;
wherein once the colour additive is mixed with the decorative base a decoration can be formed, the decoration setting in less than 24 hours, the decoration having a metallic coloured appearance once set.

4. The method according to claim 1, wherein the predetermined period of time may be less than 24 hours.

5. The method according to claim 1, wherein the predetermined period of time is 1 hour or less.

6. A decorative base for use in creating edible decorations, the decorative base comprises a quantity of a thickening/hardening compound, pure icing sugar and water wherein once the decorative base forms a decoration it will set in less than 24 hours.

7. The decorative base according to claim 6 whereafter being mixed with a colour additive, sets within 12 hours of being formed.

8. The decorative base according to claim 6 whereafter being mixed with a colour additive, sets within four hours of being formed.

9. The decorative base according to claim 6 whereafter being mixed with a colour additive, can be moulded to the required shape, or rolled flat.

10. (canceled)

11. The decorative base according to claim 6 wherein a ratio equivalent to approximately eight teaspoons of thickening/hardening compound, in the form of sodium carboxymethyl cellulose gum (CMC), is added to two cups of water.

12. The decorative base according to claim 6 wherein the ratio of pure icing sugar to the mixture is equivalent to approximately 3 gms of pure icing sugar to 14 gms of the mixture.

13. The decorative base according to claim 6 wherein the decorative base includes a quantity of potassium sorbate.

14. The decorative base according to claim 6 wherein the decorative base has an alcohol based additive mixed therein.

15. A decoration comprising a decorative base according to claim 6 mixed with an additive prior to forming the decoration, wherein the additive allows the decoration to set.

16. A decoration formed from a mixture of a decorative base and a colour additive, the decorative base comprising a quantity of a thickening/hardening compound, pure icing sugar and water, wherein the decoration sets in less than 24 hours from being created, the decoration having a colour matching the colour additive.

17. The decoration according to claim 16 wherein the colour additive is a metallic colour additive.

18. The decoration according to claim 17 wherein the colour additive is alcohol based.

19. (canceled)

20. (canceled)

21. (canceled)

22. The decoration according to claim 15 wherein the decoration remains flexible once set.

23. (canceled)

24. A decorative base for use in creating edible decorations, the decorative base comprises a hardening compound, pure icing sugar and water, wherein the quantities of each component may be equivalent to eight teaspoons of hardening compound, to two cups of water and 3 gms of pure icing sugar per 14 gms of the hardening compound and water combination.

25. (canceled)

26. The decorative base according to claim 24 wherein the decorative base becomes settable after a colour additive is mixed therein.

27. A method of creating a decorative base for use in creating edible decorations, the method comprises:
boiling water and allowing water to cool
adding 16 teaspoons of thickening/hardening compound to the water in 1 litre portions;
blending the mixture to reduce the particle size;
place the mixture in a cool region and leave for 1 hour;
dividing the mixture into 14 g portions and adding 3 gm of pure icing sugar to the mixture to provide the decorative base;
wherein once the decorative base forms a decoration it will set in less than 24 hours.

28. The method according to claim 27 further including the step of adding 5 gm of potassium sorbate per 3 litres of water before the thickening/hardening compound is added to the water.

29. The method according to claim 27 further including the step of adding 3 gm of a colour additive to the decorative base before making the decoration.

30. The method according to claim 29 wherein the colour additive is added at any time prior to using the decorative base when the colour additive is alcohol based.

31. The method according to claim 29 wherein the colour additive is added at just prior to using the decorative base when the colour additive is not alcohol based.

32. (canceled)

33. (canceled)

34. (canceled)

35. (canceled)

36. (canceled)

37. (canceled)

38. A decoration formed from a decorative base according to claim 6 wherein the decorative base is mixed with a metallic colour additive to allow the decoration to set, whereby the resulting decoration retains the metallic colour appearance once set.

39. The method according to claim 2 wherein the predetermined period of time may be less than 24 hours.

40. The method according to claim 2 wherein the predetermined period of time is 1 hour or less.

41. The method according to claim 3 wherein the predetermined period of time may be less than 24 hours.

42. The method according to claim 3 wherein the predetermined period of time is 1 hour or less.
